(19) United States
(12) Patent Application Publication
(10) Pub. No.: US 2002/0071904 A1
(43) Pub. Date: Jun. 13, 2002

(54) Method for metal coating of optical fiber grating with a long period

(76) Inventors: Un Chul Paek, Buk-gu (KR); Young Joo Chung, Kwangsan-gu (KR); Byeong Ha Lee, Kwangsan-gu (KR); Yong Gon Seo, Yeochun City (KR); Sung Jin Lee, Buk-gu (KR)

Correspondence Address: BACON & THOMAS, PLLC, 4th Floor, 625 Slaters Lane, Alexandria, VA, 22314-1176, US

(21) Appl. No.: 09/775,562

(22) Filed: Feb. 5, 2001

(30) Foreign Application Priority Data
Dec. 8, 2000 (KR) 10-2000-74465

(51) Int. Cl. G02B 6/18; B05D 5/06

(52) U.S. Cl. 427/163.2

(57) ABSTRACT

The present invention relates to a method of metal coating for an optical fiber grating with a long period. More specifically, the present invention relates to a method of using silver (Ag) as a coating material for an optical fiber through ascertaining its characteristics after silver is coated on the surface of the optical fiber using a silver mirror reaction.

The present invention shows a metal coating method for an optical fiber grating with a long period in which metal is coated on the surface of an optical fiber grating with a long period that contains a single grating or a pair of gratings, wherein silver is coated on some specific parts on the upper and lower surface of an optical fiber grating with a long period is coated with silver using a silver mirror reaction.

Hence, the present invention has the following advantages, 1) it can be used in a high temperature environment which is characteristical of a metal and can prolong the life of an optical fiber by protecting it from dampness, 2) it is very useful for device packaging since it can be soldered, 3) due to its short coating time, mass fabrication is possible. And it can have a wide range of applications such as optical fiber sensors or filters.

### BACKGROUND OF THE INVENTION

1. Field of the Invention

The present invention relates to a method of metal coating for an optical fiber grating with a long period. More specifically, the present invention relates to a method of using silver (Ag) as a coating material for an optical fiber through ascertaining its characteristics after silver is coated on the surface of the optical fiber using a silver mirror reaction.

2. Description of the Related Art

In general, the most commonly used optical fiber grating is Bragg grating where the refraction at the core of an optical fiber is periodically changed by applying strong laser light to the optical fiber. The normal period for this type of optical fiber grating are several hundreds nm and if light with multi-wavelengths composition is incident upon the optical fiber grating, the light with a specific wavelength that corresponds to the period of the optical fiber grating is reflected.

Also, the optical fiber grating with a long period means the one with its grating period that reaches several hundreds μm. The light with a specific wavelength that travels through the core of an optical fiber grating with a long period is merged into a cladding mode along the same direction. The cladding mode that merges in such a way can easily be removed by an optical fiber jacket. The optical fiber grating with a long period can be used as a band removing filter that only filters the light with a specific wavelength.

The methods for metal coating on an optical fiber as shown above, include dip coating method in melted metal, magnetron sputtering method, ion plasma deposition method and chemical deposition method.

The followings are the list of three representative publications on metal coating methods. First, D. A. Pinnow, G. D. Robertson and J. A. Wysocki, “Reductions in Static Fatigue of Silica Fibers by Hermetic Jacketting ”, Appl. Phys. Lett., vol. 34, p. 17, 1979. This publication stated that the life cycle of an optical fiber is mainly dependent on static fatigue and it has proved through experiments that the life cycle of an aluminum coated optical fiber is about 5 times longer than that of an optical fiber coated with commercial polymers. Second, D. M. costantini, C. A. P. Muller, S. A. Vasiliev, H. G. Limberger, and R. P. Salathe “Long period copper-coated grating as an electrically tunable wavelength-selective filter”, Electronic Letters Jun. 10^{th}1999, , Vol. 35, No. 12, p. 1014. This publication showed a shift in the peak value after coating an optical fiber with copper using an Evaporator and stated the possibility of it being used as a filter. Third, O. Duhem, A. DaCosta, J. F. Henninot and M. Douay″ Tunable Loss Filter based on Metal-Coated Long-period Fiber Grating″, IEEE Photobnics Technology Letters, Vol. 11, NO, November 1999. This publication showed a fringe shift after coating an optical fiber with Ti—Pt and applying heat through an electrical means and stated the possibility of it being used as a filter using this characteristic.

As explained so far, amongst the above metal coating methods, the conventional dip method is the most economical and cheapest way of coating metal, however, it is difficult to implement especially for an optical fiber grating. In other words, the usefulness of metal coating is well known but due to the difficulty of metal coating itself, the metal coated optical fibers have not been widely used.

The other conventional methods require very expensive equipment and they are very time consuming. Due to the characteristics of optical fibers, the surface should be coated uniformly, however, with the other methods excluding the dip method, a uniform coating of the entire circle was very difficult since they could only coat in a single direction. Also the adhesion with optical fibers was not very good.

### SUMMARY OF THE INVENTION

The present invention is designed to overcome the above problems of prior arts. The object of the invention is to provide a method of metal coating for an optical fiber grating with a long period that allows a simple and uniform coating of the optical fiber by causing an chemical reaction on the surface of the optical fiber through a silver mirror reaction with AgNO₃.

In order to accomplish the above objective, the present invention provides a metal coating method for an optical fiber grating with a long period in which metal is coated on the surface of an optical fiber grating with a long period that contains a single grating or a pair of gratings, wherein silver is coated on some specific parts on the upper and lower surface of an optical fiber grating with a long period is coated with silver using a silver mirror reaction.

### BRIEF DESCRIPTION OF THE DRAWINGS

FIG. 1a represents the state of silver coating on a single grating with a long period according to the first embodiment of the present invention.

FIG. 1b represents a light transmission spectrum according to the experimental results of the first embodiment.

FIG. 2a shows the state of silver coating between the gratings on the grating pair with a long period according to the second embodiment of the present invention.

FIG. 2b is a spectrum that represents the changes with respect to the length of silver coating between the gratings on the grating pair with a long period according to the experimental results of the second embodiment.

FIG. 3 shows the phase change of silver coating between the gratings of the optical fiber grating pair with a long period according to the experimental results of the second embodiment.

FIG. 4a shows the state of silver coating only on one side of optical fiber grating of the optical fiber grating pair with a long period according to the third embodiment of the present invention.

FIG. 4b is a spectrum that represents the changes with respect to the length of silver coating according to the experimental results of the third embodiment.

FIG. 5a is a spectrum which shows the state of silver coating on the optical fiber grating pair with a long period according to the fourth embodiment of the present invention.

FIG. 5b 2b is a spectrum that represents the changes with respect to the length of silver coating between the gratings on the grating pair with a long period according to the fourth embodiment.

FIG. 6a shows the state when silver is coated on the whole part of the optical fiber grating pair with a long period according to the fifth embodiment of the present invention.

FIG. 6b is a spectrum that represents the changes with respect to the length of silver coating on the optical fiber grating pair with a long period according to the fifth embodiment.

### DESRIPTION OF THE NUMERIC ON THE MAIN PARTS OF THE DRAWINGS

100: A Single Optical Fiber Grating With A Long Period

100a: Optical Fiber Grating

110, 210: Silver

200: An Optical Fiber Grating Pair with A Long Period

200a, 200b: Optical Fiber Grating

### DETAILED DESCRIPTION OF THE EMBODIMENTS

Hereinafter, preferred embodiments of the present invention will be described in detail with reference to the accompanying drawings.

First of all, the method of extracting silver for a metal coating purpose according to various embodiments of the present invention, when ammonia water was added to a solution where AgNO₃ was previously dissolved, the color of the solution turns brown and as the quantity of ammonia water gradually increases the color tuns to transparent. At this instance, silver was extracted if reducing agents such as Formalin or Rochelle salt was added.

In other words, using this principle, silver can be uniformly coated on the surface of an optical fiber grating through a silver mirror reaction. Various types of reducing agents, such as Formalin, Rochelle salt, sodium tartaric acid and glucose can be used.

Also, various experiments of the present invention showed the usefulness of the silver coated optical fiber using a silver mirror reaction after coating an optical fiber grating and a pair of optical fiber grating with silver. Hence, the conditions for an experiment to find the effects of silver on the cladding mode which was formed by the optical fiber were as follows.

According to the present invention, two types of optical fibers have been used for the experiments. One of them was a single mode fiber and the other was doped with GeO₂ and B₂O₃ at its core. The diameter of the core was 8 μm and the cutoff wavelength was 1.3 μm. In order to increase the light sensitivity, hydrogen loading was carried out at 110° C., under 120 atm., for 120 hours.

The pair of optical fibers was irradiated, through an Excimer laser (248 nm) and an amplitude mask with a grating period 350 μm, with strength of 154 mJ for 30 seconds. In this instance, the distance between the gratings was 15 cm and the length of grating was 2 cm. There were two stop bands, namely, 1.3 μm and 1.7 μm and the latter stop band was used for the experiments in the present invention.

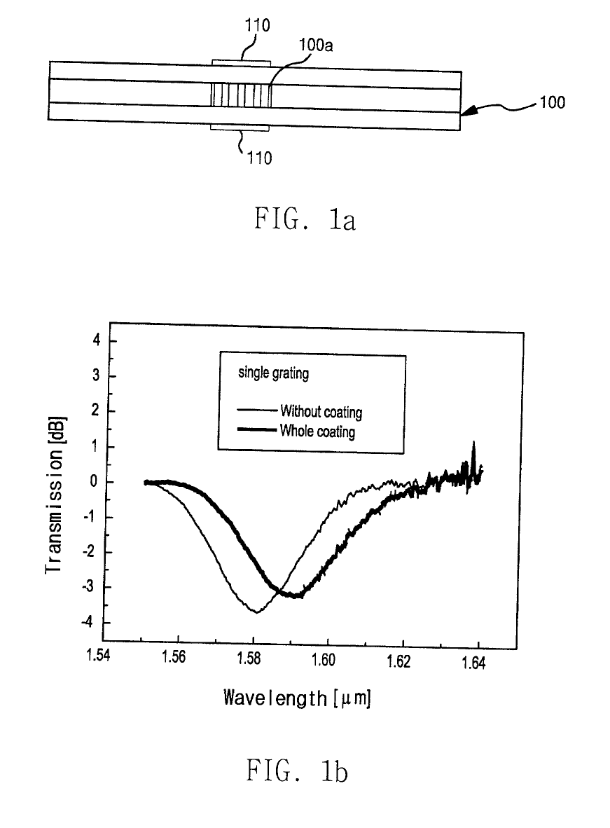

FIG. 1a represents the state of silver coating on a single grating with a long period according to the first embodiment of the present invention. FIG. 1b represents a light transmission spectrum according to the experimental results of the first embodiment.

The metal coating in FIG. 1a, shows that only silver 110 was coated on the upper and lower part of the grating 100a which was formed on the single grating with a long period 100 using a silver mirror reaction.

If the peak value were inspected on the surface of the single grating with a long period 100 after silver was coated with a thickness of 2 cm, then it could be seen that the peak value of the optical fiber grating was shifted about 10 nm towards the long wavelength.

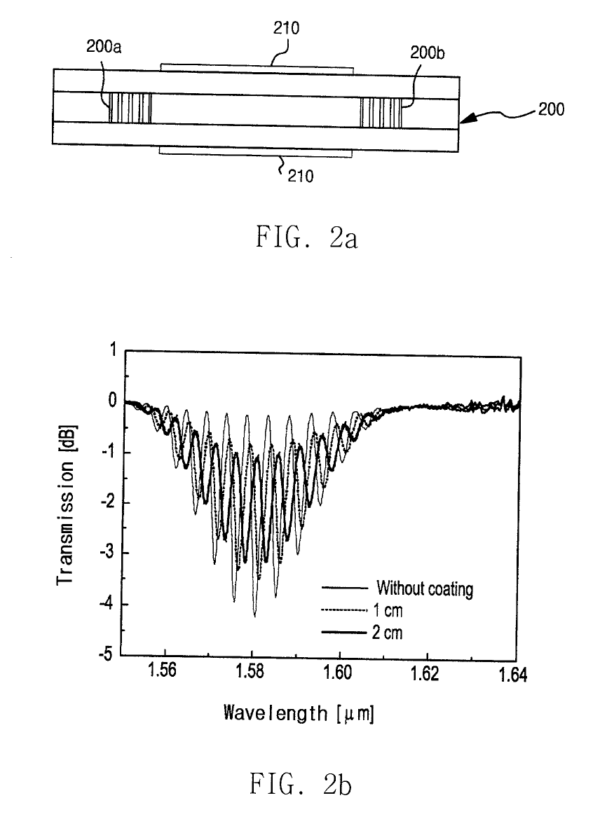

FIG. 2a shows the state of silver coating between the gratings on the grating pair with a long period according to the second embodiment of the present invention. FIG. 2b is a spectrum that represents the changes with respect to the length of silver coating according to the experimental results of the second embodiment.

In FIG. 2a, as a metal coating material, silver was used to coat between the grating 200a and grating 200b of the optical fiber grating pair 200 with a long period using a silver mirror reaction.

FIG. 2b represents a comparison between the spectrum of the silver 210 coating on each grating 200a and 200b with a length 1 cm and 2 cm respectively, and the spectrum with no coating. As the coating length increases, the loss of the cladding mode decreases and it can be seen the resonant wavelength shifts towards the long wavelength side.

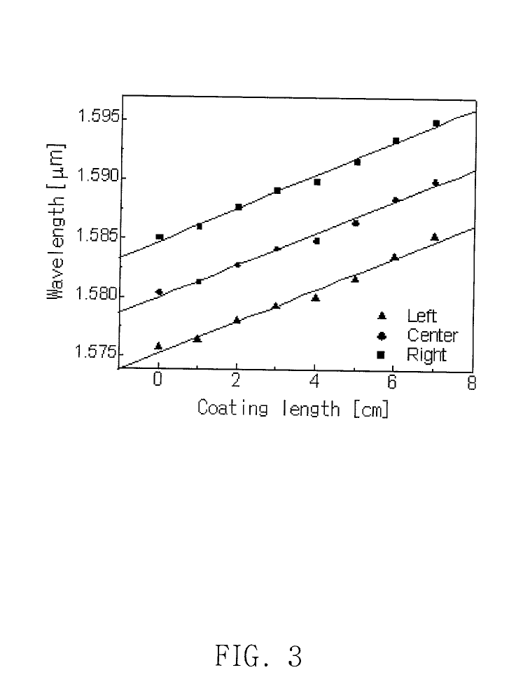

FIG. 3 shows the phase change of silver coating between the gratings of the optical fiber grating pair with a long period according to the experimental results of the second embodiment.

FIG. 3 measures the amount of movement of three fringe peaks located at the center part of FIG. 2b with respect to metal coating length and it can be seen that as the coating length increases, the peak wavelength linearly increases about 1.38 nm per every 1 cm increase in the coating length.

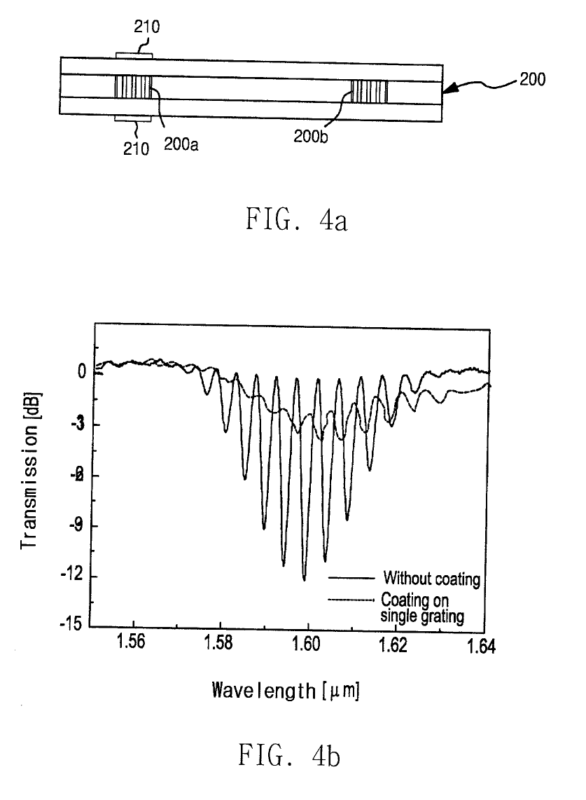

FIG. 4a shows the state of silver coating only on one side of optical fiber grating of the optical fiber grating pair with a long period according to the third embodiment of the present invention and FIG. 4b is a spectrum that represents the changes with respect to the length of silver coating according to the experimental results of the third embodiment.

In FIG. 4a, silver 210 is coated only on the upper and lower part of one side of optical fiber grating 200a of the optical fiber grating pair 200 with a long period.

At this instance, as illustrated in FIG. 4b, it was observed that the fringe contrast of the single wavelength side was markedly reduced.

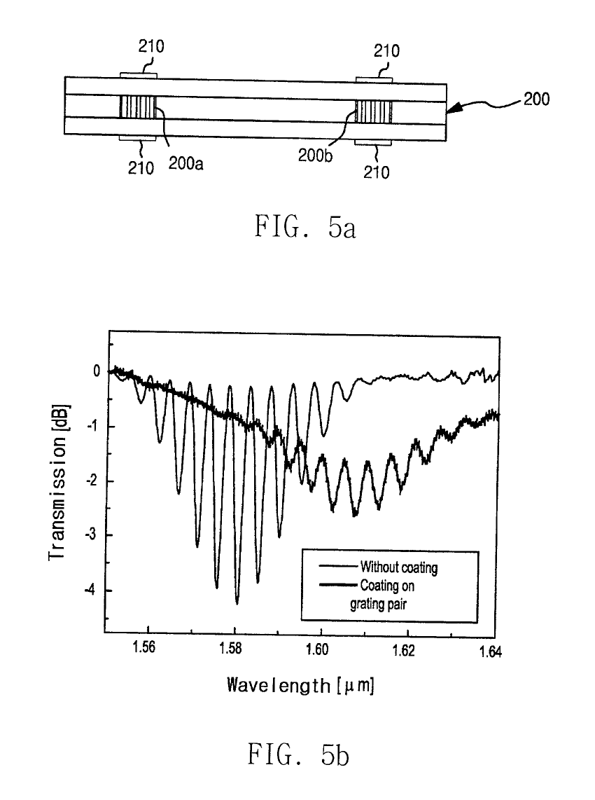

FIG. 5a is a spectrum which shows the state of silver coating on the optical fiber grating pair with a long period according to the fourth embodiment of the present invention and FIG. 5 is a spectrum that represents the changes with respect to the length of silver coating on the optical fiber grating pair with a long period according to the fourth embodiment.

As can be seen from FIG. 5a, silver 210 is coated only on the upper and lower surface of each grating 200a and 200b using a silver mirror reaction.

At this instance, as illustrated in FIG. 5b, it was observed that the contrast was markedly reduced in comparison to the case where the whole part of both gratings are coated as shown in FIG. 2b and at the same time, the whole spectrum has shifted towards the long wavelength side.

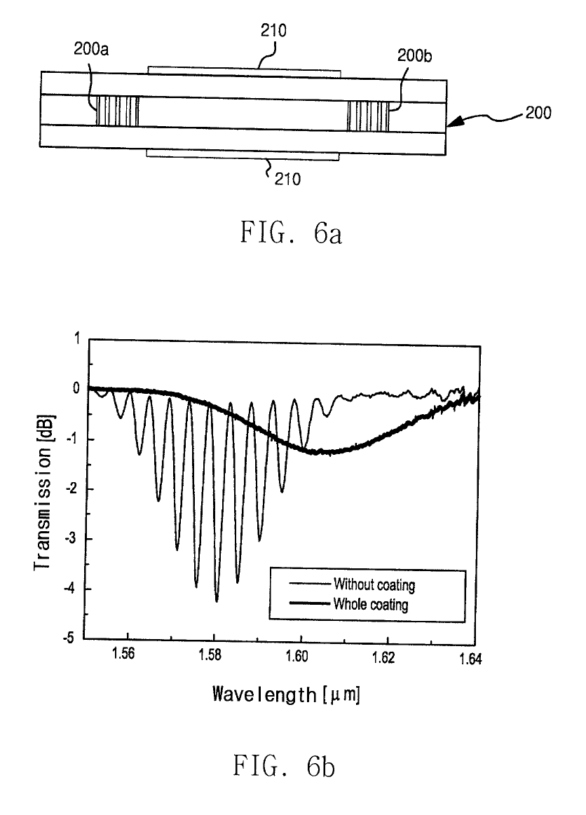

FIG. 6a shows the state when silver is coated on the whole part of the optical fiber grating pair with a long period according to the fifth embodiment of the present invention.

FIG. 6b is a spectrum that represents the changes with respect to the length of silver coating on the optical fiber grating pair with a long period according to the fifth embodiment.

In FIG. 6a, silver 210 is coated not only on the upper and lower surface of both optical fiber gratings 200a and 200b but also on the upper and lower surface between both gratings using a silver mirror reaction.

At this instance, when the whole part of the optical fiber grating pair with a long period is coated as illustrated in FIG. 6b, a spectrum like that of a single grating with a long period appears since the fringe disappears due to the loss of silver itself as illustrated in FIG. 1b. It can be seen that the main wavelength has shifted towards the long wavelength side.

As explained so far, the metal coating method for an optical fiber grating with a long period using a silver mirror reaction according to the present invention has the following advantages.

First, it can be used in a high temperature environment which is characteristical of a metal and can prolong the life of an optical fiber by protecting it from dampness. Also, it is very useful for device packaging since it can be soldered.

Second, according to the experimental results of the present invention, with silver as the coating material, the thickness can easily be adjusted through modifying the concentration of solution and the number of experiments. Also, it is economical way of coating since there is no need for expensive equipment.

Third, due to its short coating time, mass fabrication is possible. Also, it is very advantageous for device packaging since it can be soldered. It can have a wide range of applications such as optical fiber sensors or filters.

So far, the present invention which provides a method of metal coating for an optical fiber grating with a long period has been described in detail with reference to the accompanying drawings. It should be understood, however, that the detailed description and specific examples are given by way of illustration only, since various changes and modifications within the spirit and scope of the invention will become apparent to those skilled in the art from this detailed description. More specifically, the modifications pertaining to packaging of optical fiber device, soldering or welding of optical fiber and various modifications in the areas such as filters sensors and optical amplifiers.

What is claimed is:

1. A metal coating method for an optical fiber grating with a long period in which metal is coated on the surface of an optical fiber grating with a long period that contains a single grating or a pair of gratings,
wherein silver is coated on some specific parts on the upper and lower surface of an optical fiber grating with a long period is coated with silver using a silver mirror reaction.

2. A metal coating method as claimed in claim 1, wherein silver is only coated on the upper and lower surface where the grating is formed if said metal coating is for a single optical fiber grating with a long period.

3. A metal coating method as claimed in claim 1, wherein silver is only coated on the upper and lower surface between the gratings if said metal coating is for an optical fiber with a long period that contains a pair of gratings.

4. A metal coating method as claimed in claim 1, wherein silver is only coated on the upper and lower surface where a grating is formed on one side if said metal coating is for an optical fiber with a long period that contains a pair of gratings.

5. A metal coating method as claimed in claim 1, wherein silver is only coated on the upper and lower surface where a grating is formed on one and the other side if said metal coating is for an optical fiber with a long period that contains a pair of gratings.

6. A metal coating method as claimed in claim 1, wherein silver is only coated on the upper and lower surface between the whole grating pair including where a grating is formed on one and the other side if said metal coating is for an optical fiber with a long period that contains a pair of gratings.
